(19) United States
(12) Patent Application Publication
(10) Pub. No.: US 2018/0248456 A1
(43) Pub. Date: Aug. 30, 2018

(54) HOMOPOLAR ENERGY CONVERSION MACHINE

(71) Applicant: InfiniRel Corporation, Mountain View, CA (US)

(72) Inventors: Thomas A Sutrina, Bourbonnals, IL (US); Norbert H Wank, Mountain View, CA (US)

(73) Assignee: InfiniRel Corporation, Mountain View, CA (US)

(21) Appl. No.: 15/553,577

(22) PCT Filed: Feb. 24, 2016
(86) PCT No.: PCT/US2016/019394

§ 371 Date: Aug. 24, 2017

Related U.S. Application Data
(60) Provisional application No. 62/120,154, filed on Feb. 24, 2015.
(60) Provisional application No. 62/261,668, filed on Dec. 1, 2015.

(51) Int. Cl. H02K 31/02; H02K 19/06; H02K 19/10; H02K 19/20; H02K 21/24; H02K 21/36; H02K 9/20

(52) U.S. Cl. CPC H02K 31/02; H02K 19/06; H02K 19/103; H02K 9/20; H02K 21/24; H02K 21/36; H02K 19/20

(57) ABSTRACT

A machine and a method for converting between electrical and mechanical energies, the machine may include a stator with first, second (and possibly third) pole faces, a rotor assembly with first, second (and possibly third) rotors connected via a shaft. A magnetic source may be attached to either the rotor assembly or the stator. The source creates a magnetic flux field loop. The machine may include one or more electrical conductors wrapped around a portion of the stator, where the conductors may have multiple portions positioned in a gap between a stator pole face and a rotor. Current flow through all the portions flows across the stator pole face in a same direction. The magnetic source creates a magnetic flux field loop that may rotate with the rotors, causing the conductor portions to pass through the loop, and causing a conversion of energy.

### CROSS-REFERENCE TO RELATED APPLICATIONS

This application claims the benefit under 35 USC § 119 of the filing dates of U.S. Provisional Patent Application Ser. No. 62/120,154 filed on 24 Feb. 2015, and U.S. Provisional Patent Application Ser. No. 62/261,668 filed on 1 Dec. 2015. The entire disclosures of these prior applications are incorporated herein by this reference.

### TECHNICAL FIELD

The present disclosure relates generally to energy conversion machines such as motors and generators, and, in an embodiment described herein, more particularly provides a system and method for using homopolar machines to convert between mechanical and electrical energy.

### SUMMARY

In carrying out the principles of the present disclosure, a method and system is provided which brings improvements to the art of energy conversion. One example is described below in which a machine may employ permanent magnets (PMs) or excitation coils to create a magnetic flux field loop that may pass through electrical conductors when the flux stream lines move relative to the conductors. Homopolar (or Acyclic) machines generally employ sliding contacts to remove the rotating current that passes through a magnetic flux field. Steel may surround a rotor, thereby forming a containment structure, and may provide a flux return path for flux stream lines. An electrical conductor may be positioned within a path of the flux stream lines as they are rotated with the rotor. Current in the conductor may induce a vortex flux field around the conductor that can interact with flux stream lines between the north and south poles of a magnetic source (e.g., permanent magnets, electromagnets, etc.), as shown in FIG. 2. The distortion of the flux stream lines may create voltage in a generator and torque in a motor.

As seen in FIG. 2, the conductor does not move relative the stator. The conductor may be attached directly to the stator and connected directly to a voltage input or output without using brushes to make the connection. To achieve torque in the rotor for motors or voltage in the conductor for generators the flux field moves relative to the conductor. In a machine with a permanent magnet attached to the rotor, the pole face (or surface) of the permanent magnet is oriented to face the conductor(s) that are fixedly attached to the stator.

Permanent magnets create flux stream lines that exit a pole face at a perpendicular angle to the pole face, and do not move along the pole face. The pole direction in a permanent magnet is defined by the spin of electrons within the atoms of the permanent magnet material. This essentially fixes the flux stream lines to a particular location on the permanent magnet pole face. Also, since there is greater reluctance along a surface of the permanent magnet than there is when flux stream lines enter an air gap adjacent the permanent magnet, the flux stream lines exit the permanent magnets at right angles to the surface (or pole face) of the permanent magnet. If another force attempts to bend the flux stream lines relative to the surface, then the force attempting to bend the flux lines causes a force to be applied to the surface, due to the reluctance of the flux stream lines to bend relative to the surface. This resulting force will act on the permanent magnets to cause them to move in the direction of the resulting force. If the permanent magnets are mounted to the rotor, the force attempting to bend the flux stream lines may apply a torque to the rotor causing it to rotate.

Rotor rotation gives relative motion to the flux stream lines of the magnetic flux field with respect to the conductor, where the relative motion creates a current in the conductor (as in a generator), or the current in the conductor causes the flux stream lines to distort causing the rotor to move (as in a motor).

In an embodiment were the magnetic flux field is created by excitation coils made from wound conductors, each coil may be fixed relative to the stator. Another embodiment of the machine may use permanent magnets fixed relative to the stator to create the flux field.

Flux stream lines of a magnetic flux field generally follow a path of least reluctance. Therefore, flux density is proportional to relative flux permeability of a material. If a metal disk is used for a rotor and the metal disk is not a permanent magnet, but rather the disk is magnetized by a permanent magnet (or electromagnet). The magnetization of the disk may cause flux stream lines to exit a pole face of the metal disk and travel through a gap (e.g. an air gap) to a stator. However, since the magnetic field is not created by the metal disk, the location of the flux stream lines are not fixed to a position on the pole face of the rotor, thus they are not fixed with a rotation of the rotor. As the metal disk rotates the flux stream lines move angularly to maintain their position relative to the stator and move relative to the rotor. Without movement of the flux stream lines relative to the conductors, energy may not be transferred to/from the conductors.

To ensure the flux stream lines of the magnetic flux field move with the rotation of the rotor the reluctance of the metal disk may be varied relative to an angular position of the rotor as the rotor rotates. The reluctance of the metal disk may be varied by forming teeth around the perimeter of the disk. The teeth consist of peaks and valleys, where the peaks are closer to the stator than the valleys. This increased air gap between the bottom of the valley and the stator increases the reluctance as compared to the smaller air gap between the top of the peak and the stator. As the rotor rotates, the flux stream lines flowing from the pole face of the rotor experiences varied reluctance as the rotation causes a valley to appear at a location previously occupied by a peak.

Since the reluctance at the valley may be higher than that at the peak, the flux stream lines are forced to remain flowing from the peak of the metal disk, thus the flux stream lines rotate with the rotor, causing the magnetic flux stream lines to move relative to the conductors of the stator, thereby inducing a current in the conductor (in the case of a generator). As in the case of a motor, the current in the conductor will cause motion of the flux stream lines, thereby applying a force to the rotor. Since the varied reluctance restricts angular movement of the flux stream lines along the rotor's pole face, then the torque will be applied to the rotor causing the rotor to rotate.

Flux strength may be a function of angular position related to the rotor teeth. This may result in a matching change in the electromagnetic force EMF induced in the conductor(s). In the case of high rotational speed, only a few conductors in series may be needed to achieve a desired voltage so each of the series connected turns may not have an identical electromagnetic force, but the total coil voltage having a layout of turns that takes rotor teeth geometry into consideration should have identical EMF voltage or unwanted circulating currents within the stator windings may develop.

A rotor in an embodiment of the current disclosure can be made from a material composite where the reluctance and resistivity are heterogeneous. This may result in a better uniformity of the magnetic flux strength in a rotating rotor by significantly increasing the number of teeth while reducing the size of the teeth, thereby maintaining substantially the same steel area seen by the conductors (sometimes referred to as Lorentz conductors).

The rotor can be radially positioned inside the stator. However, the rotor may also be positioned radially outside the stator with a center mounted stator. Alternatively, or in addition to, the machine may include an axial approach with the stator positioned longitudinally spaced apart from the rotor along a center axis of the rotor.

The machine of the current disclosure can be configured for amplification, DC voltage, and single phase or multi-phase AC voltage grid power. At least two gaps (e.g. air, gas-filed, liquid-filed, etc.) may exist between the stator and the rotor for most machines. A DC or single phase AC configuration may have two gaps between rotor and two stators for wrapping a Lorentz winding with a back iron (e.g. housing) to complete the flux path. A three phase AC machine may have A, B, and C rotor poles with associated stators and back iron. The rotors may be on a single shaft or tube. Two excitation coils with each coil placed between adjacent ones of three stator poles may be needed to create three phase current at the A, B, and C Lorentz coils.

A poly-phase machine may follow an approach of the single and/or three phase machine with the necessary number of rotors and stators. Linear motion machines with multiple linear rotors and linear stators can be configured. These are merely rotational machines with an infinite radius and gaps between the rotor and stator. The excitation coil needs to induce a flux that passes through the gaps between magnetic pole faces which can be done by placing the rotor or stator back iron through a center of the excitation coil. A linear motion machine may use the same rotor where the stators are in line along the path of motion. For near infinitely long linear fixed identical segments of either the Lorentz conductors or a regulator coil will be activated as the mating element passes.

Field magnitude may be controlled by the chosen excitation coil or permanent magnet. Thus when applying an AC excitation current, the flux field loop matches excitation current in magnitude and direction. AC flux field at the Lorentz conductors with relative motion induces an AC EMF voltage at the ends of the Lorentz conductors and an AC current in the Lorentz conductor. DC flux field at the Lorentz conductors with relative motion induces a DC EMF voltage at the ends of the Lorentz conductors and a DC current in the Lorentz conductor. The input to these excitation coils and speed (or relative motion) together determines the resulting magnitude of energy conversion.

Another embodiment of the homopolar machine that may convert between mechanical and electrical energy may include, a stator with first and second magnetic pole faces, where the first and second pole faces may be connected via a structure (such as a metal housing). The machine may further include a rotor assembly with a first rotor fixedly attached to a second rotor via a shaft, where the first rotor, the second rotor, and the shaft rotate in unison about a center axis of the rotor assembly, where the rotor assembly rotates relative to the stator, and where each of the first and second rotors may include at least one magnetic pole face. The machine may further include a first gap between the stator's first magnetic pole face and the first rotor, a second gap between the stator's second magnetic pole face and the second rotor, and a first electrical conductor, where multiple portions of the first electrical conductor may be fixedly attached to at least one of the first and second magnetic pole faces of the stator, where the multiple portions are positioned in at least one of the first and second gaps, and where a current travels through each of the multiple portions in the same direction relative to the respective pole face to which the multiple portions are attached. The machine may further include at least one magnetic source which may create a magnetic flux field loop, where the magnetic flux field loop rotates about the center axis of the rotor, thereby causing the conductor portions of the first electrical conductor to pass through the magnetic field loop as the loop rotates.

Another embodiment of the homopolar machine may include, a first stator which may be a ring with an inner cylindrical surface and teeth positioned around an outer perimeter of the ring, a first rotor which rotates about a center axis and rotates relative to the first stator, where the first rotor is a disk with teeth positioned around an outer perimeter of the disk, and where the first rotor is concentrically positioned within the first stator. The machine may further include a first conductor helically wrapped around the ring between the inner surface and the outer perimeter, wherein portions of the first conductor may be positioned side-by-side on the inner surface, where a current flowing through each one of the portions of the first conductor flows in the same direction across the inner surface of the stator as current flowing through the other portions of the first conductor. The machine may further include a first gap between the teeth of the first rotor and the inner cylindrical surface of the first stator, and at least one magnetic source which creates a magnetic flux field loop, where the magnetic flux field loop rotates about the center axis of the rotor, thereby causing the portions of the first conductor to pass through the magnetic field loop as the loop rotates.

Another embodiment of the homopolar machine may include, a stator with a center axis and an inner cylindrical surface, a rotor with a center axis which is aligned with the center axis of the stator, an electrical conductor which is wrapped around the stator, where current in all portions of the conductor that are positioned along the inner cylindrical surface travels in a same direction relative to the inner surface. The machine may further include at least one magnetic source which creates a magnetic flux field loop, where flux stream lines of the magnetic flux field loop travel around the magnetic source from a north pole of the source to a south pole of the source, where magnetic flux flows along the flux stream lines, and where the magnetic field rotates with the rotor, and thereby rotates the magnetic flux field loop through the portions of the conductor.

A method of converting between mechanical energy and electrical energy may include the steps of connecting a stator with first and second magnetic pole faces to a housing of a machine, and attaching first and second rotors to a shaft thereby forming a rotor assembly, where the first rotor, the second rotor, and the shaft rotate in unison about a center axis of the rotor assembly, where the rotor assembly rotates relative to the stator, and where each of the first and second rotors include at least one magnetic pole face. The method may further include the steps of assembling the rotor assembly into the housing, thereby forming a first gap between the stator's first magnetic pole face and the first rotor, and a second gap between the stator's second magnetic pole face and the second rotor. The method may further include the steps of wrapping an electrical conductor around at least a portion of the stator, where multiple portions of the electrical conductor are fixedly attached to at least one of the first and second magnetic pole faces of the stator, where the multiple portions are positioned in at least one of the first and second gaps, and where current travels through each of the multiple portions in the same direction relative to the respective pole face to which the multiple portions are attached. The method may further include the steps of creating a magnetic flux field loop in the machine by positioning at least one magnetic source within the machine, rotating the magnetic flux field loop about the rotor's center axis, thereby causing the conductor portions of the electrical conductor to pass through the magnetic field loop as the loop rotates, and converting electrical energy to mechanical energy or mechanical energy to electrical energy in response to the rotating the magnetic flux field loop through the electrical conductor portions.

These and other features, advantages and benefits will become apparent to one of ordinary skill in the art upon careful consideration of the detailed description of representative embodiments of the disclosure below and the accompanying drawings, in which similar elements are indicated in the various figures using the same reference numbers.

### BRIEF DESCRIPTION OF THE DRAWINGS

FIG. 1A is a schematic representation of top view of a homopolar (acyclic) generator.

FIG. 1B is a schematic representation of side view of the homopolar (acyclic) generator of FIG. 1a.

FIG. 2 is a representative block diagram of a homopolar generator/motor illustrating effects on magnetic flux lines as a magnetic field rotates past an electrical conductor.

FIG. 3 is a schematic representation of a perspective view of a homopolar energy conversion machine with a two-tooth rotor and an excitation coil where the machine embodies principles of the present disclosure.

FIG. 4 is a schematic representation of a perspective view of a homopolar energy conversion machine with a permanent magnet rotor where the machine embodies principles of the present disclosure.

FIG. 5 is a schematic representation of a perspective cross-sectional view of an embodiment of a homopolar machine that embodies principles of the present disclosure.

FIG. 6 is a representative cross-section view of the machine of FIG. 5.

FIG. 7 is a 2D finite element model showing representative paths of flux stream lines for a magnetic flux field loop in the machine of FIG. 5.

FIG. 8 is a schematic representation of a perspective cross-sectional view of another embodiment of the homopolar machine.

FIG. 9 is a 2D finite element model showing representative paths of flux stream lines for a magnetic flux field loop in the machine of FIG. 8.

FIG. 10 is a schematic representation of a perspective cross-sectional view of yet another embodiment of the homopolar machine.

FIG. 11 is a 2D finite element model showing representative paths of flux stream lines for a magnetic flux field loop in the machine of FIG. 10.

FIG. 12 is a schematic representation of a perspective cross-sectional view of yet another embodiment of the homopolar machine.

FIG. 13 is the schematic representation of a perspective cross-sectional view of the homopolar machine of FIG. 12 with additional elements removed.

FIG. 14 is a 2D finite element model showing representative paths of flux stream lines for a magnetic flux field loop in the machine of FIG. 12.

FIG. 15 is a representative block diagram of a 3-phase homopolar generator/motor using similar components as used in the other embodiments of the homopolar machine.

### DETAILED DESCRIPTION

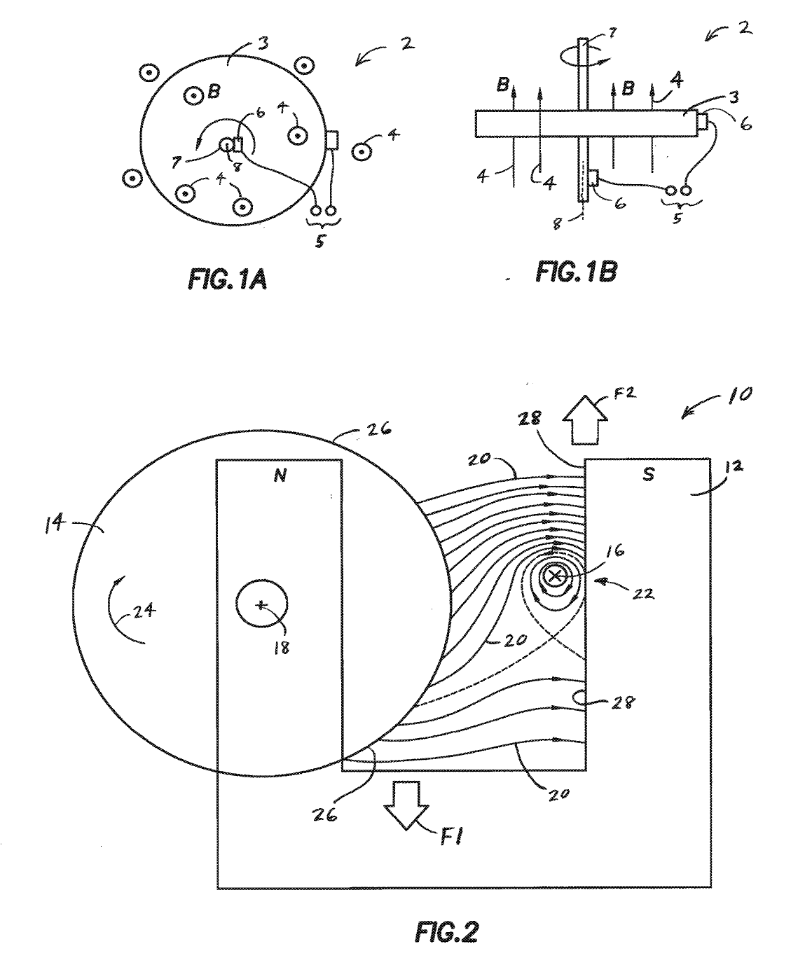

FIGS. 1A and 1B shows top and side views, respectively, of a simple version of a homopolar machine 2 that can convert mechanical energy to electrical energy, or electrical energy to mechanical energy. The basic components of the machine 2 are an electrical conducting disk 3 that can rotate about the center axis 8, a shaft 7 used to drive rotation of the disk 3 or be driven by rotation of the disk 3, sliding contacts 6 used to apply a voltage and current to the shaft 7 and the conducting disk 3 or receive back EMF voltage and current from the shaft 7 and disk 3, conductor ends to apply voltage to or receive voltage from the machine, and a magnetic field with flux lines 4 passing through the disk 3 at right angle to its surface.

For motor operation, a voltage and current is supplied to the machine 2 via contacts 5. This creates a voltage across sliding contacts 6, causing current to flow between the contacts 6, which flows through the shaft 7 and disk 3. The flow of current through the disk is generally perpendicular to the flow of flux stream lines 4 through the disk 3. As current flows relative to the flux stream lines 4, a torque is created on the disk 3 and causes the disk 3 and shaft 7 to rotate about axis 8. The shaft 7 rotation can be connected to various other devices to transfer mechanical energy to the devices.

For generator operation, a rotational force can be applied to the shaft 7 by an external device. Rotation of the shaft 7 causes the disk 3 to rotate within the magnetic field flux stream lines 4. This relative motion between the conductor disk 3 and the flux stream lines 4 induces a flow of current between the contacts 6 and creates an EMF voltage at the contacts 5 which can be used to transfer electrical energy to other devices. However, one reliability issue with such a machine 2 may be the sliding contacts 6. These are constantly experiencing friction between the shaft 7 and disk 3. This friction may degrade the contacts 6 over time and may limit the rotational speed of the disk 3. The current disclosure provides embodiments of a homopolar machine 10 that may not require sliding contacts to deliver or generate electrical energy to/from the machine. As used herein, the term “homopolar” may refer to a rotor with pole faces that have the same polarity, where the polarity of each pole face is oriented in a same direction relative to a center axis of the rotor, or “homopolar” may refer to a stator with pole faces that have the same polarity, where the polarity of each pole face is oriented in a same direction relative to a center axis of the stator.

FIG. 2 is a representative end view of a simple homopolar machine 10 that embodies principles of the current disclosure. The machine 10 may include a rotor 14, a stator 12, a conductor 16, a gap 15 (e.g. air) between the rotor 14 and stator 12, and a magnetic field with flux stream lines 20. The rotor 14 may pivot about the center axis 18. The rotor's outer surface may be referred to as the rotor's magnetic pole face 26, since the magnetic flux stream lines 20 exit or enter the gap 15 through the pole face 26. The rotor's pole face 26 has a low reluctance to flux flow parallel to the axis 18 and high reluctance to the flux flow tangentially around the pole face 26. The stator 12 may include a U-shaped structure made from a low reluctance material, such as steel, a permanent magnetic, etc. The stator 12 has north N and south S magnetic poles. The stator 12 may include a pole face 28 which may have a low reluctance to magnetic flux 20 flowing into the pole face 28. The U-shaped stator provides a return path from the south S pole to the north N pole through the material of the stator 12. A path between the rotor pole face 26 and the stator pole face 28 may have a low reluctance to flux flow. The stator and/or rotor may include a permanent magnetic or electromagnet that creates the magnetic flux field with the flux stream lines 20.

An electrical conductor 16 may be positioned in the gap 15 between the stator 12 and the rotor 14. FIG. 2 indicates a gap between the conductor 16 and the stator 12. This can be due to insulation around the conductor 16, but it should be understood that the conductor 16 is fixedly attached to the stator 12 and is not free to move relative to the stator 12. Therefore, any translational force applied to the conductor 16 is transferred to the stator 12 via the attachment. Current in the conductor 16 is shown as flowing out of the FIG. 2 by the cross. Flow in the conductor may induce a vortex 22 in the flux lines 20 traveling between the rotor and the stator. Alternatively, movement of the flux stream lines 20 relative to the conductor 16 may induce current flow in the conductor 16.

An interaction between the flux stream lines 20 and a current through the conductor 16 is seen in FIG. 2. Current flowing through the conductor 16 as the magnetic flux stream lines 20 rotate through the conductor 16 may create a vortex 22 of flux stream lines 20 around the conductor 16. The flux stream lines 20 straighten out as they move farther away from the current in the conductor 16, which indicates a reduction in the interaction. One of the flux stream lines 20 is shown as a dashed line, which is used to generally indicate a separation between ones of the flux stream lines 20 that are highly interactive with the current in conductor 16 and create the vortex 22 around the conductor, and the ones of the flux stream lines 20 that do not orbit the conductor in the gap 15 and generally travel from the rotor pole face 26 to the stator pole face 28. The upper portion of the flux stream lines 20 in the vortex 22 that orbit the conductor 16 may flow in a same direction as the flux stream lines 20 above and below the vortex. However, the lower portion of the vortex 22 flux stream lines 20 may flow in an opposite direction relative to the flux stream lines 20 above and below the vortex 22.

The bending of the flux stream lines 20 creates a force F1 that acts on the rotor and an equal reaction force F2 that acts on the conductor 16. Since the conductor 16 is fixedly attached to the stator 12, then the force F2 is applied to the stator, also. Therefore, the force F1 creates a torque 24 that causes the rotor 14 to rotate in response to the interaction of the flux stream lines 20 with current flowing in the conductor 16. For a generator, an applied torque 24 (i.e. force F1) forces the flux stream lines 20 to pass through the conductor 16, thereby inducing a current in the conductor that generates an EMF voltage at the ends of the conductor 16.

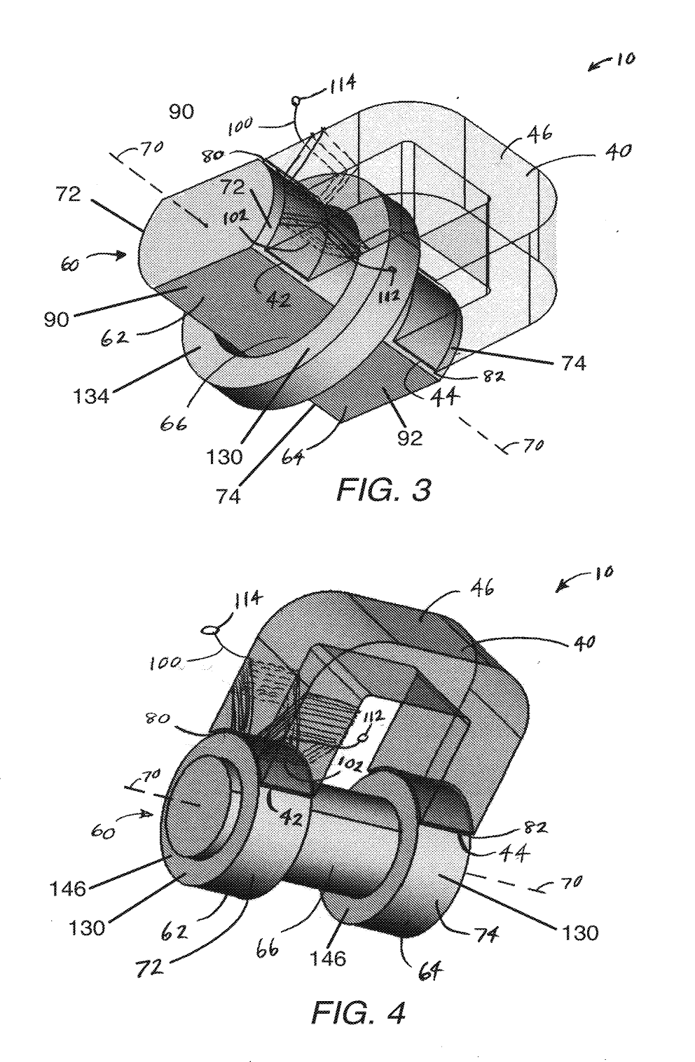

FIGS. 3 and 4 show representative views of simple configurations of a homopolar machine 10. Referring to FIG. 3, the machine 10 includes a two teeth rotor assembly 60, a C-shaped stator 40, and a magnetic source 130. The rotor assembly 60 may be seen as having first and second rotors 62, 64, connected by a shaft 66. In this configuration, the cross-sectional shape of the first and second rotors 62, 64 are shown as having the same cross-sectional shape as the shaft 66. The rotor assembly 60 can be made from a single piece of low reluctance material, with a double-D-shaped cross-section, as seen in FIG. 3.

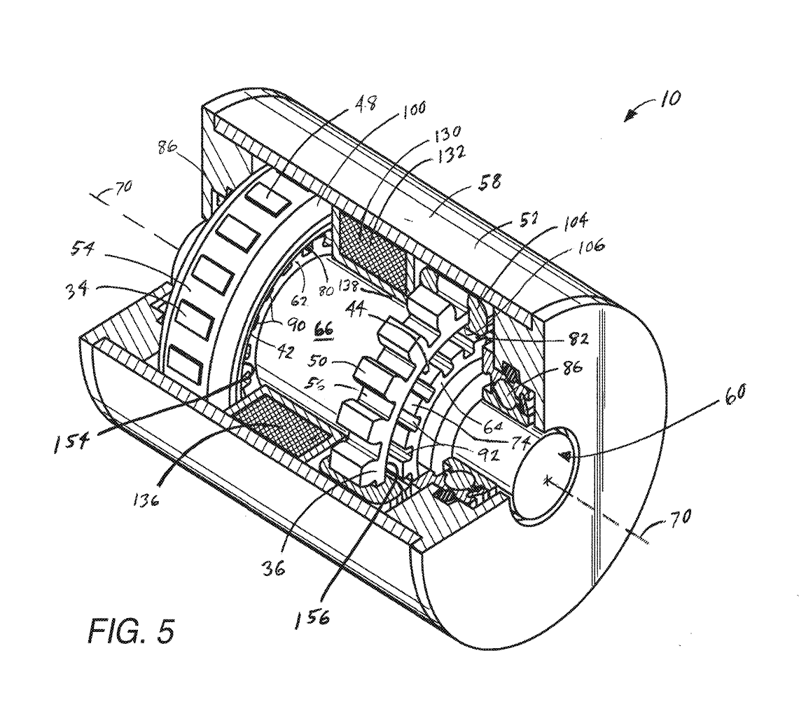

However, these elements may have different characteristics such as cross-sectional shapes, diameters, varied reluctance, etc. For example, the rotors 62, 64 can be cylindrical and radially enlarged relative to the shaft 66 (as seen in FIG. 4). The rotor 62 can be a permanent magnet, with the rotor 64 being merely a low reluctance material (e.g. steel) without being a permanent magnet. Additionally, the rotors 62, 64 may have a D-shaped cross-section with a single pole face 72, 74 on each rotor 62, 64, respectively, or the rotors 62, 64 may have more than two pole faces 72, 74, respectively, such as seen in at least FIG. 5. Also, the reluctance of each rotor 62, 64 and the shaft 66 may have different reluctances relative to each other. Therefore, it is understood that many variations of the rotor assembly 60 are possible in keeping with the principles of this disclosure. All of these variations can be used in any of the embodiments of the machine 10.

Referring back to FIG. 3, the stator may be C-shaped as shown, or it may be various other shapes, such as V-shaped, semicircle-shaped, C-shaped with tubular cross-section, etc. The stator 40 may include two pole faces 42, 44 connected together by a structure 46, which can be a return path for flux flow in a magnetic flux field loop. FIG. 3 also shows a magnetic source 130 as being an electromagnet 134 that is circumferentially positioned around the shaft 66. Again, the shaft 66 can be a radially reduced from that which is shown in FIG. 3, with the electromagnet 134 reduced in diameter to accommodate the reduced diameter of the shaft 66. The stator 40 also includes a conductor 100 that is wrapped around portions of one end of the structure 46. FIG. 3 shows only one end of the structure 46 wrapped with the conductor 100, but the other end can be wrapped with an extended length of conductor 100, and/or wrapped with another conductor 104 (see at least FIG. 5) with conductor portions 106 positioned on the pole face 44 and in the gap 82.

FIG. 3 shows the conductor 100 wrapped down a right side portion of the end of the structure 46, along the pole face 42, and up a left side of the end, with half of the wraps positioned across a front side of the end and half of the wraps positioned across a back side of the end. Various other conductor 100 wrappings are possible as long as the wrapping is routed around the structure 46 as to minimize creation of inductance when the energy conversion process is active. Portions 102 are indicated as the segments of the conductor 100 that are positioned along the pole face 42 and in the gap 80. These portions 102 may be positioned side-by-side with little or no gap between each portion 102. However, the gap between them can be large, depending upon the desired characteristics of the machine 10. It may also be desirable to position the portions 102 generally parallel to the center axis 70.

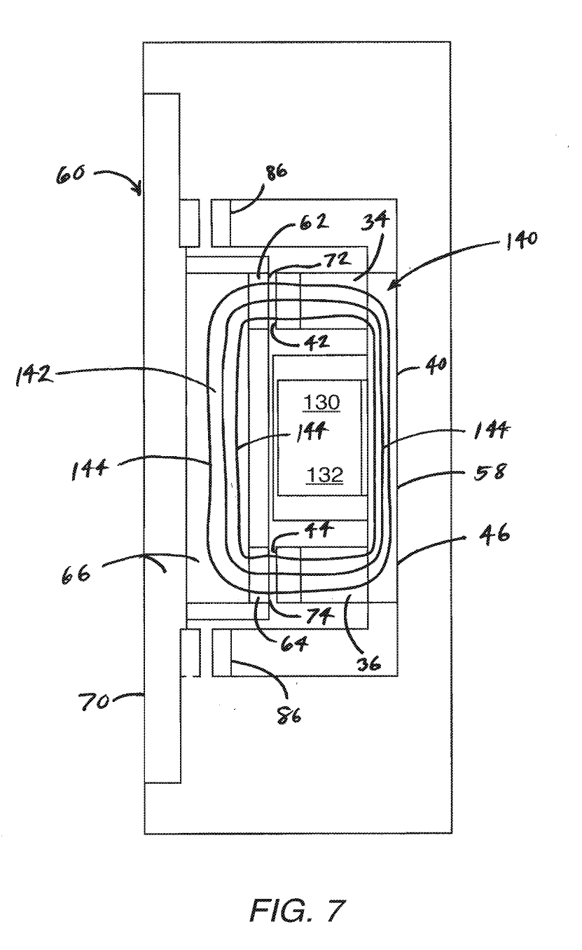

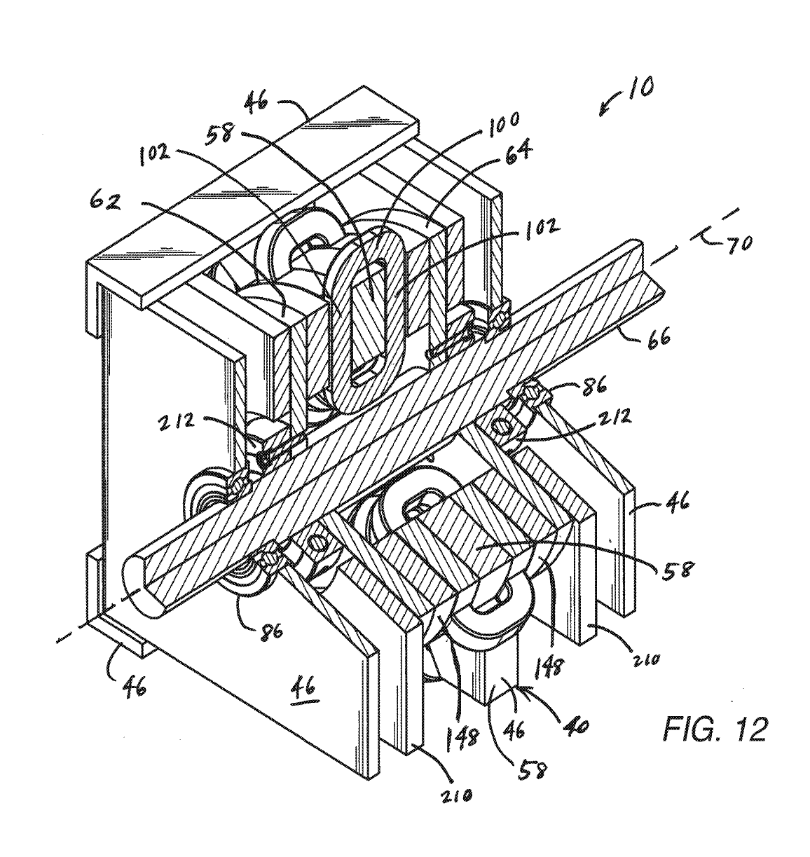

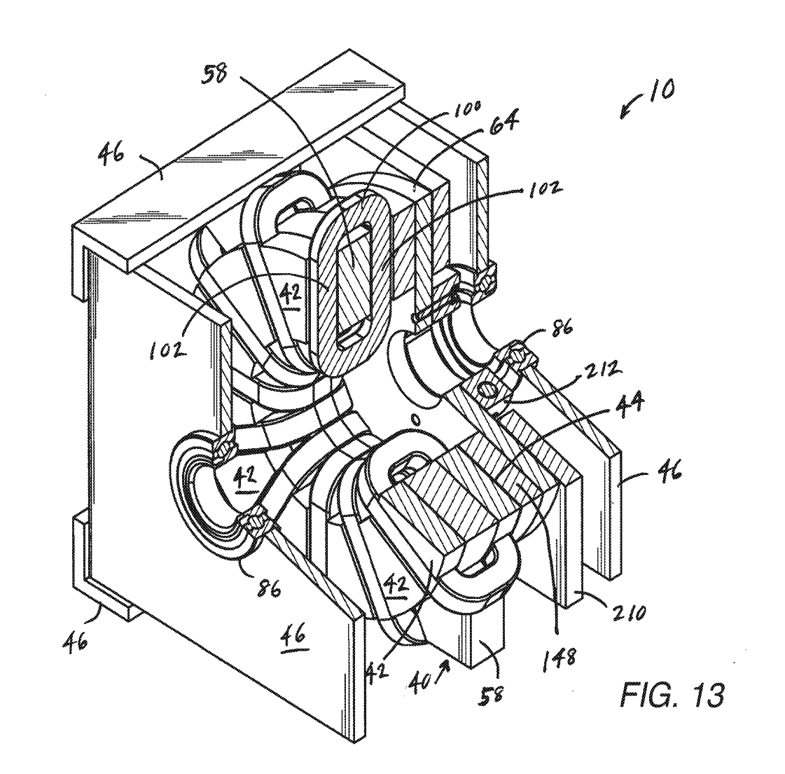

However, it is not required that these portions be positioned in parallel with the center axis 70. They can be angled relative to the center axis 70, but the energy transfer in the machine 10 may be more efficient when the portions 102 are generally parallel to the center axis 70. It should be understood, however, that the orientation of the portions 102 is more critically related to the magnetic flux stream lines 144 (see at least FIG. 7). The portions 102 should be generally perpendicular to the flux stream lines 144 whether they are parallel with the center axis 70 or not. For example, FIGS. 12 and 13 show an orientation of the portions 102 of the conductor 100 which are perpendicular to the center axis 70 of the rotor assembly 60.

When the excitation coil of the electromagnet 134 is energized, a magnetic flux field loop 140 is created with the flux stream lines 144 of the loop being generally confined to travel within the stator structure 46, through the pole faces 42, 44, and through the rotor assembly 60. Few flux stream lines enter and exit the electromagnet 134 due to the characteristics of the magnetic flux field loop of the electromagnet 134. If the rotor assembly 60 is rotated due to an applied torque, then current is induced in the conductor portions 102 by the interaction of the magnetic flux field loop 140 and the conductor portions 102, and thus current will flow in the conductor 100 creating an EMF voltage between the opposite ends 112, 114 of the conductor 100.

If a voltage is applied to the opposite ends 112, 114, then current will flow through the conductor 100 causing an interaction with the magnetic flux field loop 140 around the conductor portions 102, thereby generating a torque on the rotor 62, 64 and causing the rotor assembly to rotate. Since the rotor assembly is made from a material, such as steel, the recesses 90, 92 may be required to vary the reluctance that the flux stream lines 144 see as the rotor assembly 60 rotates, which prevents the flux stream lines 144 from traveling along the rotor pole faces 72, 74. Without the recesses 90, 92, the rotor assembly would not see an applied torque, since the flux lines would freely move along the pole faces 72, 74. However, recesses 90, 92 may not be necessary if the rotors are permanent magnets as seen in FIG. 4.

FIG. 4 is similar to the machine 10 of FIG. 3, except that the rotors 62, 64 are radially enlarged relative to the shaft 66, the rotors 62, 64 are each permanent magnets 146 with pole faces 72, 74, respectively. The wrapping of the conductor 100 is very similar, except there are more wraps of the conductor 100 than in FIG. 3. This illustrates that any number of wraps may be utilized in constructing the machine 10. The machine 10 of FIG. 4 uses the permanent magnets 146 as the magnetic source 130 for creating the magnetic flux field loop 140. Please note that the polarity of the pole face 72 should be opposite the polarity of the pole face 74 on the rotor assembly 60, and therefore, the pole faces 42 and 44 on the stator should also be opposite polarity from each other. If only one of the rotors 62, 64 were a permanent magnet 146 and the other of the rotors 62, 64 were a metal ring, then the polarities of the pole faces 42, 44, 72, 74 would be determined by the permanent magnet 146. This could be the case, where the rotor 62 is merely a bearing assembly which rotatably connects the stator structure 46 with the rotor assembly 60. In this embodiment, the conductor 100 may be wrapped on the end of the stator structure 46 with the pole face 44, with no conductor wrapped one the pole face 42.

With the permanent magnets 146 in FIG. 4, the electromagnet 132 shown in FIG. 3 is not needed. Also, as stated above, the permanent magnets 146 may not need recesses 90, 92 to cause the magnetic flux field loop 140 to rotate with the rotor assembly 60. The varied reluctance provided by recesses 90, 92 for the rotors 62, 64 in FIG. 3 is not needed with the machine 10 of FIG. 4. The permanent magnets 146 restrict movement of the flux stream lines 144 across the pole faces 72, 74 by fixing the stream lines 144 to a position on the pole faces 72, 74. As above, if the rotor assembly 60 is rotated due to an applied torque, then current is induced in the conductor portions 102 by the interaction of the magnetic flux field loop 140 and the conductor portions 102, and thus current will flow in the conductor 100 creating an EMF voltage between the opposite ends 112, 114 of the conductor 100. If a voltage is applied to the opposite ends 112, 114, then current may flow through the conductor 100 causing an interaction with the magnetic flux field loop 140 around the conductor portions 102, thereby generating a torque on the rotor 62, 64 and causing the rotor assembly 60 to rotate.

FIG. 5 shows a representative perspective view of a homopolar machine 10 with more structural details, but in general, it is similar to the machine 10 in FIG. 3. The magnetic source 130 of the machine 10 in FIG. 5 is an electromagnet 132 which is positioned circumferentially around the shaft 66 and is positioned in between the two stator pole faces 42, 44. The excitation coil 134 includes multiple circumferential wraps of a coil conductor 136. A gap 138 is provided to prevent physical interference of the electromagnet 132 with the rotor assembly when the rotor assembly 60 rotates relative to the electromagnet 132. The rotors 62, 64 mat be made from a low reluctance material (e.g. steel), therefore, recesses 90, 92 may be needed in the pole faces 72, 74, respectively, to restrict movement of the flux stream lines 144 along the pole faces 72, 74.

FIG. 5 shows the rotors 62, 64 as resembling cogged gears, with teeth on an outer perimeter of the rotors 62, 64. The top of each tooth is a segment of the pole face 72 or 74. Each rotor 62, 64 has multiple segments in its respective pole face 72, 74. The teeth, with the recesses and the peaks, causes a gap 80, 82 between the rotor 62, 64 and its respective stator pole face 42, 44, to vary in distance, which varies a distance flux stream lines 144 must travel when traveling through the gap 80, 82. The increased distance in the recesses 90, 92 increases the reluctance to flow of the magnetic flux 142 along the flux stream lines 144 in the recesses 90, 92 as compared to the reluctance seen by the flux stream lines 144 when traveling between the peaks (or segments of the pole faces 72, 74) and the stator pole faces 42, 44.

The machine 10 includes a stator 40 with a structure 46 (may also be referred to as a housing 52) that houses two rings 34, 36 fixedly attached to the structure 46, two bearing assemblies 86 for rotatably connecting end portions of the shaft 66 with the structure 46, and an electromagnet 132 that is mounted to a portion 58 of the structure 46. This portion 58 is also used as a flux path in the magnetic flux field loop 140 (see FIG. 7). Each ring 34, 36 includes an inner cylindrical surface 154, 156, respectively, and an outer surface with circumferentially spaced apart recesses 54, 56. The outer surface of each ring 34, 36 can be a respective pole face 48, 50, with multiple segments in each pole face 48, 50, the multiple segments being separated by the recesses 54 or 56. The rotors 62, 64 are positioned along the center axis 70 and aligned axially with the stator rings 34, 36. The rotors 62, 64 rotate within the rings 34, 36 with a minimal gap 80, 82 between the respective pole faces 72, 74 and the pole faces 42, 44. The gap shown in FIG. 5 is not to scale and is shown more exaggerated for clarity, but in practice, the gap will be as narrow as possible while providing sufficient clearance for the rotors 62, 64 to rotate freely within the machine 10.

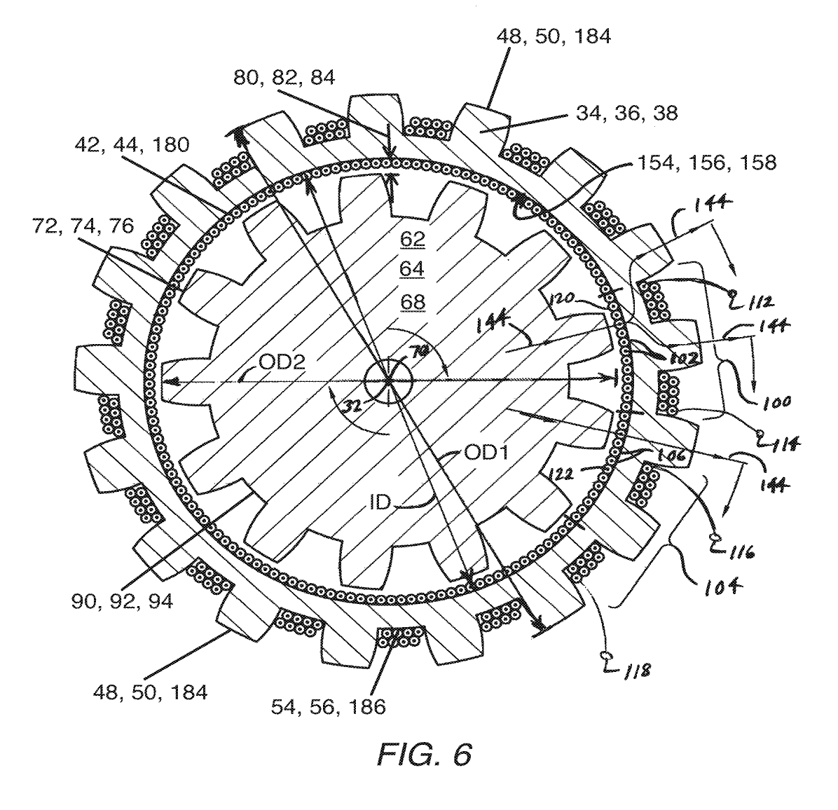

A conductor 100 may be wrapped around the ring 34 to form a bundle of conductor turns that continue circumferentially around the ring 34. As in the other embodiments above, portions 102 of the conductor 100 are positioned on the pole face 42 and in the gap 80. These features are more easily seen in FIG. 6, which is described below. Similarly, conductor 104 may be wrapped around the ring 36 to form a bundle of conductor turns that continue circumferentially around the ring 36. Portions 106 of the conductor 104 are positioned on the pole face 44 and in the gap 82. These conductor portions 102 and 106 provide the interaction with the flux stream lines 144 of the magnetic flux field loop 140 that causes the energy conversion in the machine 10. However, it is not a requirement that the conductors 100 and 104 be wrapped around rings 34, 36, respectively. Both conductors may be wrapped around a single ring 34 or 36. There may also be additional conductors wrapped around each ring 34, 36, to create the proper voltage levels on an output of the conductors, or to be able to receive the proper voltage levels to operate the machine 10.

The recesses in the rings 34, 36 provide areas to lay the conductors 100, 104 between the peaks of the rings as they are wrapped around the rings 34, 36, with the peaks on the outer perimeter of the rings providing a low reluctance path through the rings 34, 36 from the inner cylindrical surfaces 154, 156 to the pole faces 48, 50.

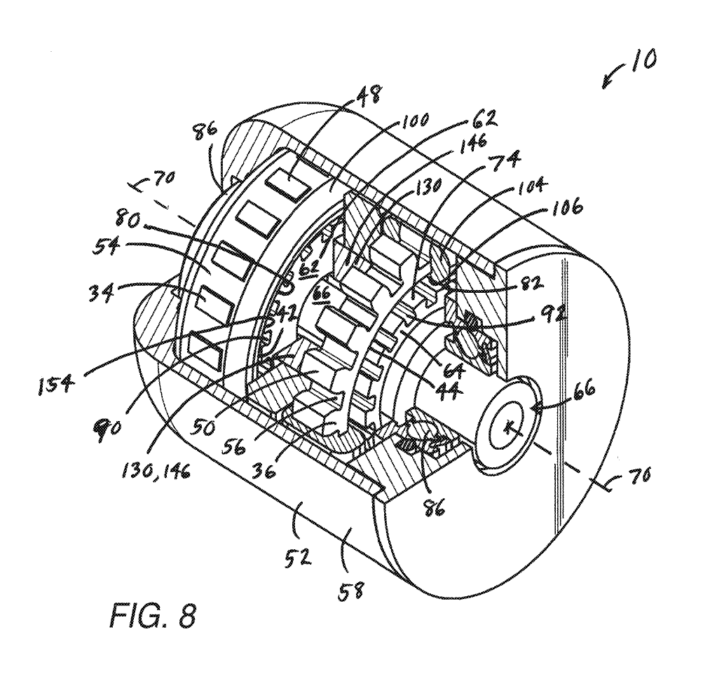

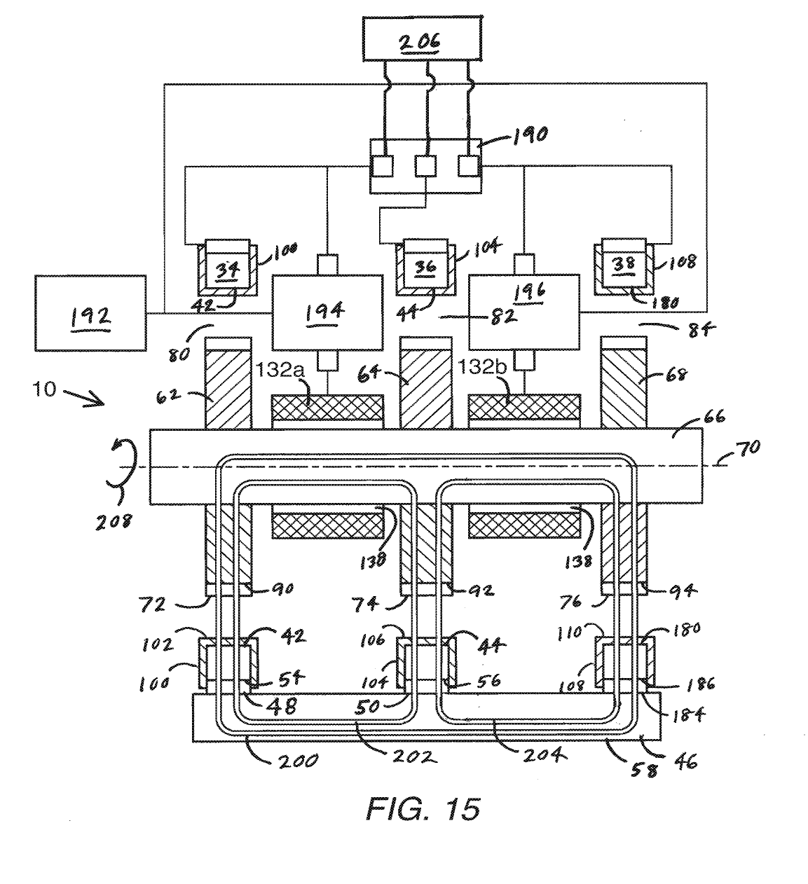

FIG. 6 shows a representative cross-sectional view of the rotor 62 positioned within the stator ring 34. The view is illustrative of the rotor 64 positioned within the ring 36, as seen in FIGS. 5, 8. It also illustrative of a rotor 68 positioned within a ring 38, as seen in the block diagram in FIG. 15. FIG. 6 indicates the rotors 62, 64, 68, the rings 34, 36, 38, the stator pole faces 42, 44, 180, the outer stator pole faces 48, 50, 184, the gaps 80, 82, 84, the rotor pole faces 72, 74, 76, the recesses 54, 56, 186 and the inner cylindrical surfaces 154, 156, 158, respectively. However, the discussion of FIG. 6 will focus on the elements of the first grouping of elements (related to the rotor 62 and stator ring 34), which will be synonymous with descriptions of the remaining other two groupings (related to the rotor 64 and stator ring 36, and rotor 68 and stator ring 38). Therefore, the discussion of the first grouping will generally apply to the other two groupings.

In FIG. 6, the rotor 62 rotates about the center axis 70 and is axially positioned on the center axis 70 in alignment with the stator ring 34, with a gap 80 between the rotor pole face 72 and the stator pole face 42. The stator ring 34 has a center axis 32 which is aligned with the center axis 70. The gap 80 is the difference in a radial distance from the inner diameter ID of the stator ring 34 to the outer diameter OD2 of the rotor 62. At least conductor portions 102 are positioned along the inner cylindrical surface 154 (i.e. pole face 42) of the stator ring 34, but many other conductor portions can also be positioned along the inner cylindrical surface 154 as shown. The recesses 90 in the rotor's outer diameter OD2 provide a varying reluctance as the rotor 62 rotates which may be needed if the rotor is not a permanent magnet 146. Other configurations of the rotor 62 may be used as long as the reluctance between the rotor pole face 72 and the stator pole face 42 varies at an azimuth position on the stator pole face 42 as the rotor 62 rotates.

FIG. 6 shows a cross-sectional view of multiple conductors (at least conductors 102, 104) wrapped around the ring 34. The conductor 100 may be wrapped around the ring 34 along the section of the rotor 62 indicated by the bracket labeled 100. The indicated section can be larger or smaller than the size indicated in FIG. 6 by the bracket 100, so it is understood that the machine 10 is not limited to the particular details shown in FIG. 6 for conductor wrapping of the stator ring 34. Conductor 100 is shown wrapped around the ring 34 from the inner cylindrical surface 154 to recesses 54 in the pole face 48. The conductor 100 may be wrapped along the inner surface 154 creating one conductor portion 102, then wrapped up and over a recess 54, then back to the inner surface 154 where another conductor portion 102 is positioned along side the previously positioned portion 102. This wrapping of conductor 100 can be continued to produce a row 120 of conductor portions 102 positioned side-by-side circumferentially along the inner surface 154.

The conductor 104 may be wrapped around the ring 34 along the section of the rotor 62 indicated by the bracket labeled 104. The conductor 104 may be wrapped along the inner surface 154 creating one conductor portion 106, then wrapped up and over a recess 54, then back to the inner surface 154 where another conductor portion 106 is positioned along side the previously positioned portion 106. This wrapping of conductor 104 can be continued to produce a row 121 of conductor portions 106 positioned side-by-side circumferentially along the inner surface 154. This process can continue with multiple other conductors to create a uniform positioning of similar conductor portions around the inner perimeter of the stator ring 34. Multiple layers of the conductor portions on surface 154 can also be provided, if desired.

It should be understood that wrapping the conductors 100, 104 in this manner causes the conductor portions 102, 106 to be oriented generally in a same direction with respect to the rotor pole face 72, the rotor axis 70 and the flux stream lines 144. Therefore, current that flows through conductors 100, 104 will cause current flowing in all of the portions 102 and 106 to flow in a same direction relative to each other. This allows for substantially constant rotation of the rotor 62 when a DC voltage is applied to the conductor ends 112, 114 and 116, 118. AC voltages may also be applied to the ends 112, 114 and 116, 118 which will also cause the rotor 62 to rotate in a motor configuration. Constant DC EMF voltage can be provided at the ends 112, 114 and 116, 118 by rotation of the rotor 62 at a constant RPM.

The flux stream lines 144 in FIG. 6 illustrate two possible paths through the rotor pole face 72, the gap 80, the conductor portions 102, 106, the stator pole face 42, the ring 34 and the pole face 48. Due to the increased reluctance in the recesses 90, both flux stream lines 144 exit the rotor at the peaks (segments of pole face 72). The upper flux stream line 144 passes through the row 120 of conductor portions 102, through the pole face 42, and into the body of the ring 34. Because of the increased reluctance caused by the recess 54 in the outer diameter OD1 of the stator ring 34, the flux stream line 144 splits with roughly half of the flux flowing in the stream line 144 being diverted to the peak above the recess 54, and the remaining portion of the flux flowing in the stream line 144 being diverted to the peak below the recess 54. This helps cancel inductance that might be created by the flow of the flux through the windings in tangential directions. The split flux stream lines 144 then exit the ring 34 through separate segments of the pole face 48 and through a gap into a surrounding portion 58 of the structure 46 (not shown).

The lower flux stream line 144 exits a peak on the outer diameter OD2 of the rotor 62, then through the row 121 of conductor portions 106, the pole face 42, on through a peak in the outer diameter OD1 of the ring 34, and through a gap into a surrounding portion 58 of the structure 46 (not shown). As the rotor 62 rotates (as indicated by the rotational arrows), the flux stream lines 144 rotate with the rotor 62 creating the interaction with the conductor portions 102, 106 which may induce current flowing in the same direction in all the conductor portions. Alternatively, as similarly stated previously, the interaction may impart rotational torque on the rotor 62 when current is caused to flow in the same direction through all the conductor portions 102, 106, thereby rotating the rotor 62.

FIG. 7 shows a representative 2D finite element model of a portion of the machine 10 shown in FIG. 5. Notice the identification of the structural elements on the finite element model, such as the center axis 70, the rotor assembly 60, the rotors 62, 64, the shaft 66, the stator rings 34, 36, the bearing assemblies 86, the pole faces 42, 44, 72, 74, and the electromagnet 132 as the magnetic source 130. The flux stream lines 144 indicate the path of the magnetic flux field loop 140 along which the magnetic flux 142 flows. The electromagnet 132 creates the magnetic flux field loop 140, with almost none of the flux stream lines 144 entering or exiting the electromagnet 132.

A majority of the flux stream lines 144 pass through the structure portion 58, the pole face 72, the pole face 42, the shaft 66, the pole face 74, the pole face 44 and back to the portion 58. Therefore, at least a portion of the shaft 66 (preferably an outer portion) needs to be made from a low reluctance material so the flux has a low reluctance path between the two rotors 62, 64. The direction of flow of the flux stream lines 144 can be either clockwise or counter-clockwise. Therefore, indications of flux flow in this disclosure do not require that the flow be in that direction. The description is merely describing a flow path for purposes of discussion, but it does not necessarily limit the flow of magnetic flux to the directions described.

FIG. 8 shows another embodiment of the machine 10 which is similar to the machine 10 in FIG. 5. Similar elements are indicated with the same reference numerals. FIG. 8 differs from FIG. 5 where the magnetic source 130 is one or more permanent magnets 146 instead of an electromagnet 132. Also, the shaft 66 is a reduced diameter to allow the permanent magnet(s) 146 to be longitudinally positioned between the rotors 62, 64, with rotors 62, 64 radially reduced to a diameter less than the outer diameter OD2 of the rotors 62, 64. A longitudinal gap between each of the rotors 62, 64 and the permanent magnet(s) 146 should be minimized to reduce reluctance to flux flow between either one of the rotors 62, 64 and the permanent magnet(s) 146. The shaft 66 may be made from a material that has a high reluctance to prevent flux flow through the shaft 66 in this embodiment. Otherwise, the operation of the machine 10 is very similar to that of the machine 10 in FIG. 5.

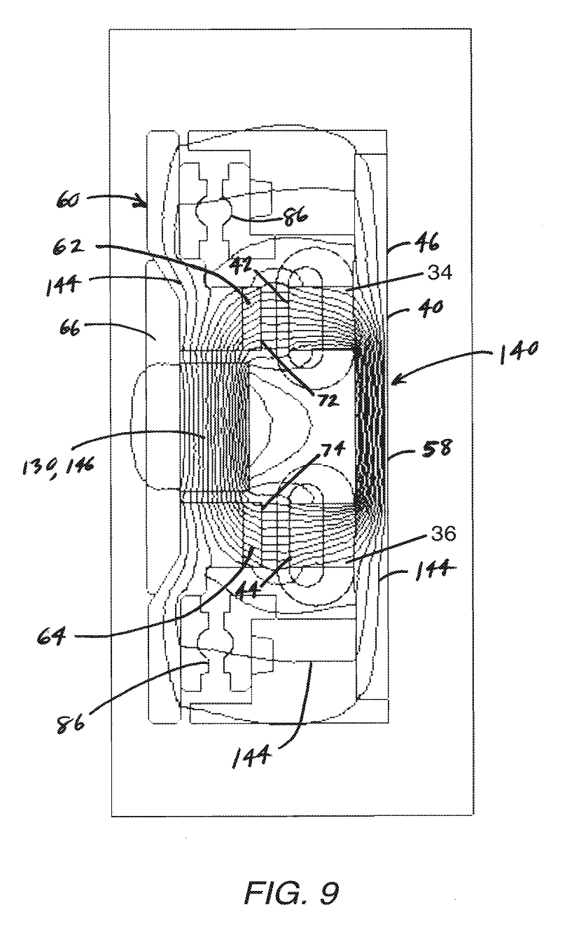

FIG. 9 shows a representative 2D finite element model of a portion of the machine 10 shown in FIG. 8. Notice the identification of the structural elements on the finite element model, such as the center axis 70, the rotor assembly 60, the rotors 62, 64, the shaft 66, the stator rings 34, 36, the bearing assemblies 86, the pole faces 42, 44, 72, 74, and the permanent magnet(s) 146 as the magnetic source 130. The flux stream lines 144 indicate the path of the magnetic flux field loop 140 along which the magnetic flux 142 flows. The permanent magnet(s) 146 create the magnetic flux field loop 140. Where the machine 10 in FIG. 5 had almost none of the flux stream lines 144 entering or exiting the electromagnet 132, the machine in FIG. 8 has almost all of the flux stream lines 144 entering or exiting the permanent magnet(s) 146. This is a possible reason to make the shaft 66 out of a high reluctance material to help direct the flux stream lines 144 through the permanent magnet(s) 146.

A majority of the flux stream lines 144 pass through the structure portion 58, the pole face 42, the pole face 72, the permanent magnet(s) 146, the pole face 74, the pole face 44 and back to the portion 58. A low reluctance path between the rotors 62, 64 is provided by permanent magnet(s) 146 and the small longitudinal gaps between the permanent magnet(s) 146 and each of the rotors 62, 64. The direction of flow of the flux stream lines 144 can be either clockwise or counter-clockwise. Therefore, indications of flux flow in this disclosure do not require that the flow be in that direction. The description is merely describing a flow path for purposes of discussion, but it does not necessarily limit the flow of magnetic flux to the directions described.

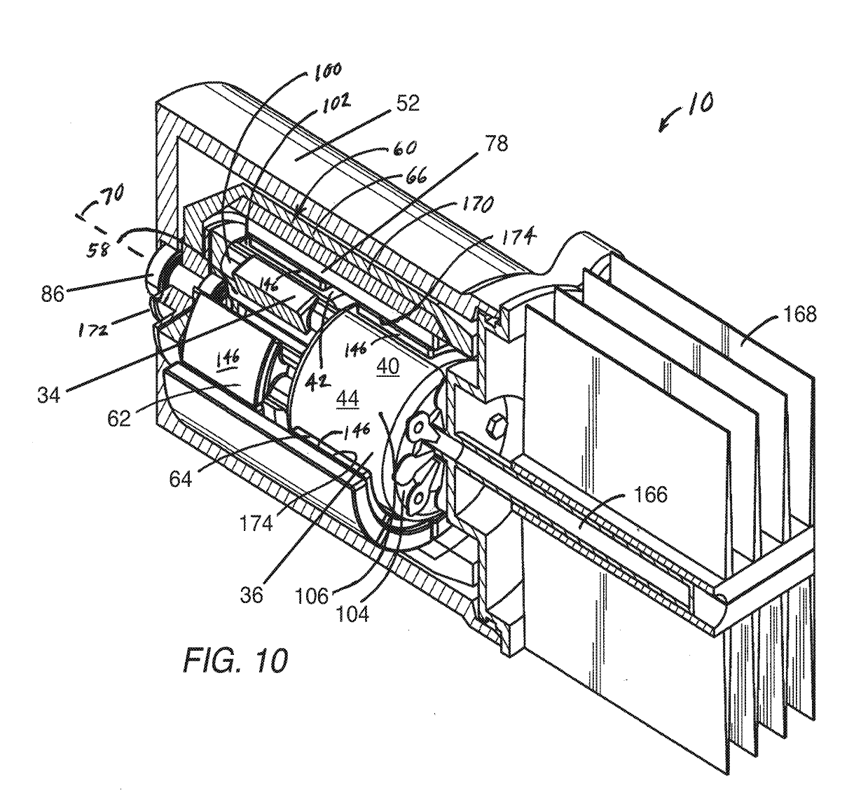

The embodiment shown in FIG. 10 may differ from the previous embodiments in that the rotors 62, 64 and a cylindrical portion 170 of the shaft 66 rotate radially outside the stator 40, with the stator 40 being positioned radially inward from the rotors 62, 64. The rotor assembly 60 can include a cylindrical portion 170 that is open at one end and tapered to a radially reduced portion 172 at the opposite end. This radially reduced portion 172 can be rotatably mounted to the housing 52 via a bearing assembly 86. The rotors 62, 64 can include multiple permanent magnets 146 mounted to rotor segments 78. Each segment 78 can have one or more permanent magnets 146 of rotor 62 mounted proximate one end of the segment 78, with an equal number of permanent magnets 146 of rotor 64 mounted proximate an opposite end of the segment 78. Therefore, each segment 78 contains matched pairs of rotor 62 magnets 146 and rotor 64 magnets 146. The magnetic polarity orientation of the poles for the rotor 62 magnets 146 will be opposite the magnetic polarity orientation of the poles for the rotor 64 magnets 146. Each segment 78 may provide a low reluctance flux flow path between the permanent magnets 146 in the rotor 62 and the permanent magnets 146 in the rotor 64. Therefore, each rotor 62, 64 consists of a grouping of permanent magnets 146 circumferentially spaced around an inner surface 174 of the cylindrical portion 170, with the permanent magnets 146 attached to the segments 78. The segments 78 maintain a longitudinal spacing between the permanent magnets 146 of the rotors 62, 64.

The stator rings 34, 36 have similar conductor 100, 104 wrappings as mentioned above, with the conductor portions 102, 106 positioned generally parallel with the center axis 70. It is to be understood, that it is not a requirement that the conductor portions 102, 106 be parallel to the center axis 70, just that it is preferred that the conductor portions 102, 106 are parallel to the center axis 70 in this embodiment. Other wrapping directions are permitted, but energy conversion efficiencies may be reduced with other wrappings.

The stator rings 34, 36 are mounted to the structure portion 58 which is inside the rings. The portion 58 provides a low reluctance flux flow path between the rings 34, 36. A heat pipe 166 (or any other suitable heat transfer medium) can be used to extract heat from the machine 10 to be dissipated into a surrounding environment through the heat exchanger 168. This embodiment can be used to store mechanical energy by maintaining a high speed rotation of the rotor assembly 60. When input excitation current is lost, the inertia in the rotor assembly 60 can begin to generate voltage at the output contacts which can be used to maintain power to a device to allow for normal shutdown, if desired. The other embodiments can also be used as a mechanical energy storage device.

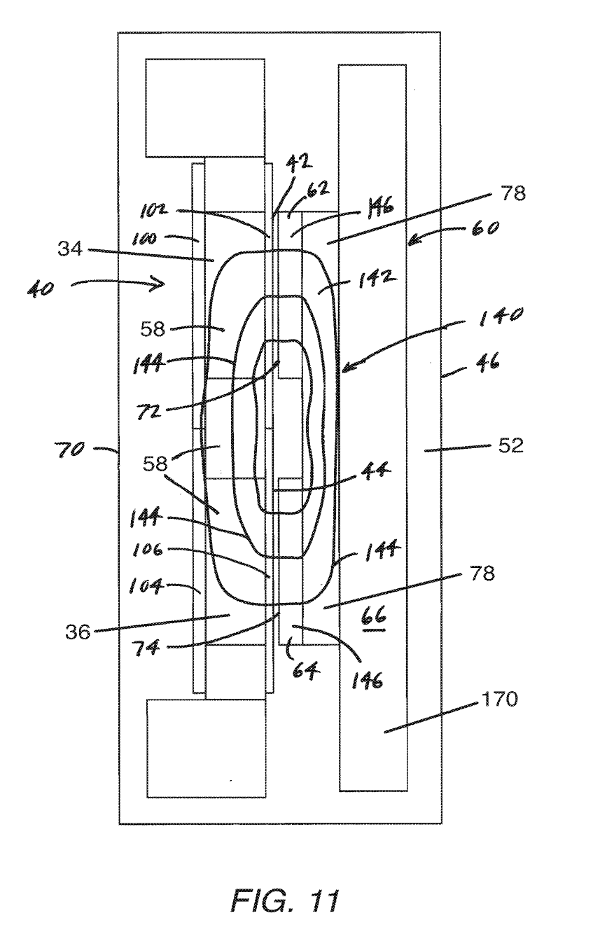

FIG. 11 shows a representative 2D finite element model of a portion of the machine 10 shown in FIG. 10. Notice the identification of the structural elements on the finite element model, such as the center axis 70, the rotor assembly 60, the rotors 62, 64, the shaft 66 (or cylindrical portion 170), the stator rings 34, 36, the pole faces 42, 44, 72, 74, and the permanent magnet(s) 146 as the magnetic source 130. The flux stream lines 144 indicate the path of the magnetic flux field loop 140 along which the magnetic flux 142 flows. The permanent magnet(s) 146 create the magnetic flux field loop 140.

A majority of the flux stream lines 144 pass through the structure portion 58, the pole face 44, the pole face 74, the rotor 64 permanent magnet(s) 146, the segment 78, the pole face 72, the pole face 42 and back to the portion 58. A low reluctance path between the permanent magnet(s) 146 of rotors 62, 64 is provided by the segment 78. The direction of flow of the flux stream lines 144 can be either clockwise or counter-clockwise. Therefore, indications of flux flow in this disclosure do not require that the flow be in that direction. The description is merely describing a flow path for purposes of discussion, but it does not necessarily limit the flow of magnetic flux to the directions described.

FIGS. 12-13 show another embodiment of the machine 10 with rotors and stator rings that are axially aligned and longitudinally spaced apart along the center axis 70. FIG. 13 is merely FIG. 12 with a few elements removed for clarity. The rotors 62, 64 can be washer-shaped rotors with a washer-shaped permanent magnet 148 mounted to one face of each of the washer-shaped rotors 62, 64. The permanent magnet 148 mounted on the rotor 62 is mounted to the face of the rotor 62 that faces the rotor 64, and the permanent magnet 148 mounted on the rotor 64 is mounted to the face of the rotor 64 that faces the rotor 62. A collet 212 is mounted to an opposite face of each rotor 62, 64 from the face the permanent magnet 148 is mounted. The collet is used to fixedly attach the rotors 62, 64 to the shaft 66 that is rotatably attached to the structure 46 via bearing assemblies 86. Each rotor 62, 64 rotates about the center axis 70. Rotor 62 is positioned on an opposite side of a generally washer-shaped stator 40 from the rotor 64. Several sets of conductors 100 with portions 102 can be wrapped around the stator 40.

An additional flux flow path may be needed next to the rotors 62, 64 to carry flux traveling in the magnetic flux field loop. The additional structure 210 can be mounted close enough to each rotor 62, 64 to receive flux flow from the rotor 62, 64 and transfer the flux from the portion 58 to the rotor 62, 64. The additional structure 210 can be mounted on the same side of the rotor 62, 64 that the collet 212 is mounted. The additional structure 210 can have a cutout to provide clearance for the collet and allow the structure 210 to be placed close to the rotor 62, 64, but not touching the rotor 62, 64 to allow free rotation of the rotor without the additional structure 210 having to rotate with the rotor 62, 64.

The stator 40 is generally washer-shaped with recesses on both sides of the stator 40. The recesses are circumferentially spaced apart around the stator 40, and portions of the sets of conductors 100 are positioned within the recesses on opposite sides of the stator. Therefore, as seen clearly in FIG. 13, the multiple sets of conductor wrappings form multiple toroidal shapes which are circumferentially spaced apart around the stator 40. The portion 58 is shown as a middle portion of the washer-shaped stator 40. The portion 58 provides a low reluctance flux flow path between the pole faces 42, 44 (face 44 is on opposite side of stator 40 from pole face 42, but is not shown in drawing), and provides the structure around which the conductors 100 are wrapped. This embodiment illustrates that the magnetic source 130 can be at many locations around the magnetic flux field loop.

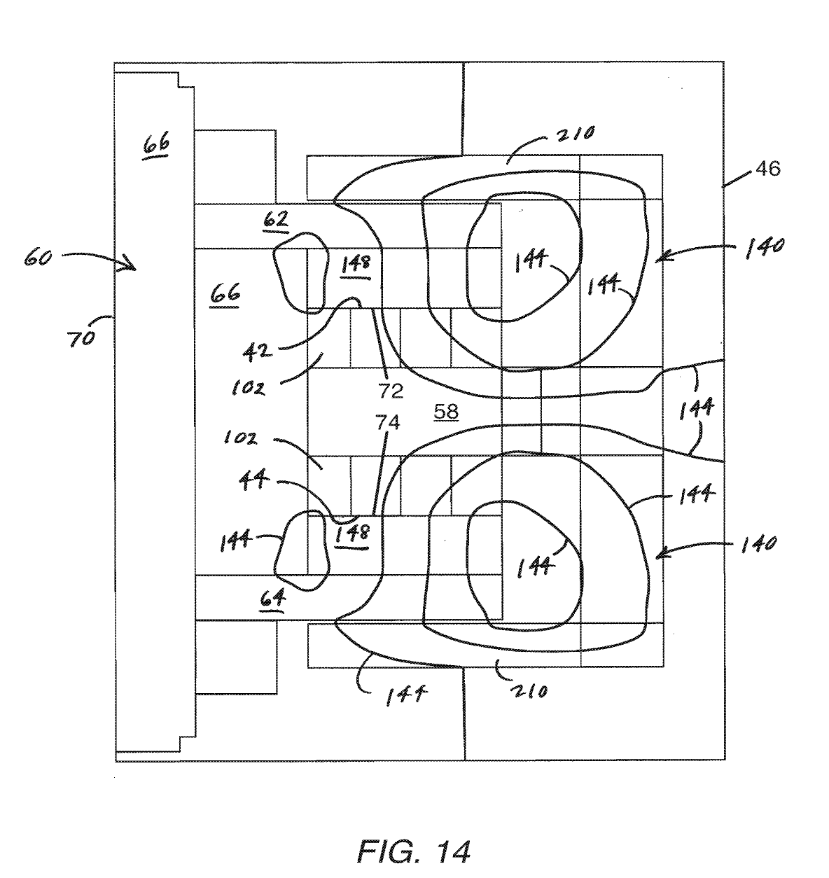

FIG. 14 shows a representative 2D finite element model of a portion of the machine 10 shown in FIGS. 12-13. Notice the identification of the structural elements on the finite element model, such as the center axis 70, the rotor assembly 60, the rotors 62, 64, the shaft 66, the bearing assemblies 86, the structure 58, the conductor portions 102, the structure 46, the additional structure 210, the pole faces 42, 44, 72, 74, and the washer-shaped permanent magnet(s) 148 as the magnetic source 130. The flux stream lines 144 indicate the path of the magnetic flux field loop 140 along which the magnetic flux 142 flows. The permanent magnet(s) 148 create the magnetic flux field loop 140.

There are two distinct magnetic flux field loops 140. Both share a flux path through the structure portion 58. One loop 140 goes through the structure 58, the upper additional structure 210, the rotor 62, the permanent magnet(s) 148, the pole face 42, the pole face 72, conductor portions 102, and back to the portion 58. The other loop 140 goes through the structure 58, the lower additional structure 210, the rotor 64, the permanent magnet(s) 148, the pole face 44, the pole face 74, conductor portions 102, and back to the portion 58. The direction of flow of the flux stream lines can be either clockwise or counter-clockwise. Therefore, indications of flux flow in this disclosure do not require that the flow be in that direction. The description is merely describing a flow path for purposes of discussion, but it does not necessarily limit the flow of magnetic flux 142 to the directions described.

FIG. 15 is a block diagram for a 3-phase homopolar machine. Similar items are indicated with the same reference numerals. Machine 10 may include a third rotor 38, in addition to the two rotors 62, 64. The rotors and stator rings and pole faces are similar to those described above regarding at least FIGS. 5 and 8. Therefore, their operation will not be described again since their operation is generally the same as it is for those items in FIGS. 5 and 8.

Two electromagnets 132a, 132b are positioned about the shaft 66 with electromagnet 132a longitudinally positioned on the shaft 66 between adjacent rotors 62, 64, and electromagnet 132b being longitudinally positioned on the shaft 66 between adjacent rotors 64, 68. A gap 138 is maintained between the electromagnets 132a, 132b to ensure rotation of the rotor assembly 60 without contacting the inside diameters of either of the electromagnets 132a, 132b. The electromagnets 132a, 132b create magnetic flux field loops 200, 202, 204. The loop 200 indicates flux flow through the conductor portions 102, 108. The loop 202 indicates flux flow through the conductor portions 102, 106. The loop 204 indicates flux flow through the conductor portions 106, 108. A direction of flux flow in the loops 200, 202, 204 is determined by the excitation voltage applied to the electromagnets 132a, 132b by the excitation drivers 194, 196, respectively. Also, a flux field magnitude of the flux loops 200, 202, 204 is controlled by an amplitude of current provided to the electromagnets 132a, 132b by the drivers 194, 196, respectively.

Excitation drivers 194, 196 power the electromagnets 132. The excitation drivers are bi-directional in that they can provide either positive or negative voltages to the excitation coils in the electromagnets 132a, 132b, respectively. A controller 192 provides power control signals to the excitation drivers 194, 196, which communicates to each driver 194, 196 the desired current amplitude and voltage polarity to apply to the respective electromagnets 132a, 132b. The controller 192 can also monitor the voltage and current at the 3-phase connection 190 to adjust the desired current amplitude and voltage polarity settings to the respective drivers 194, 196. The conductors 100, 104, 108 associated with stator rings 34, 36, 38 can be directly connected to the load 206 through the 3-phase connection 190 for a generator operation, or connected to a power source 206 for a motor operation. This determines the current amplitude and direction in the portions 102, 106, 110 of the conductors 100, 104, 108, respectively.

In a 3-phase motor operation of the machine 10, a 3-phase connection to a grid power 206 (i.e. utility power grid) is made at the 3-phase connection 190. For discussion purposes only, phase A could connect to the conductor 100, phase B could connect to conductor 104, and phase C could connect to conductor 108. However, it is not required for these phases to be connected in this manner. With a 3-phase grid connection, phases A, B, C each provide AC voltage and current to the machine 10 at connection 190. As the polarity of the voltage and amplitude of the current changes in the phases A, B, C, the voltage polarity and current amplitude changes in each of the conductors 100, 104, 108, respectively. In order to synchronize the varied voltage and current in the conductors 100, 104, 108 with maintaining a rotation of the rotor assembly 60, the bi-directional excitation drivers 194, 196 can dynamically change the voltage polarity and current amplitude applied to the electromagnets 132a, 132b to cause the interaction between the magnetic flux field loops 200, 200, 204 and the respective conductor portions 102, 106, 110 to apply a torque to the rotor assembly in a same direction regardless of the polarity of the voltage at the connection 190. Controlling the drivers 194, 196 via the controller 192 can also adapt the drivers 194, 196 to the phase shifts of the three phase input power.

In a 3-phase generator operation of the machine 10, a 3-phase connection to a 3-phase load 206 is made at the 3-phase connection 190. For discussion purposes only, conductor 100 could supply phase A to the load 206, conductor 104 could supply phase B to the load 206, and conductor 108 could supply phase C to the load 206. However, it is not required for these phases to be connected in this manner. To create a 3-phase VAC output, a torque 208 can be applied to the rotor assembly at a substantially constant RPM. As used herein, “substantially constant RPM” refers to an RPM that is maintained to within +/−10% of a desired RPM of the rotor assembly 60. Also, it is not required for the RPM to be maintained at a substantially constant RPM, but it is preferred that the RPM is substantially constant. The electromagnets 132a, 132b are energized by the bi-directional excitation drivers 194, 196 to create the magnetic flux field loops 200, 202, 204. The interaction of the loops 200, 202, 204 (as described in more detail above) with the conductor portions 102, 106, 110 determine the direction and amplitude of induced current in the portions 102, 106, 110, and thereby determine the voltage polarity, and magnitude and direction of the output current at the connection 190 for each phase A, B, C. By controlling the voltage polarity and current amplitude applied to the electromagnets 132a, 132b, the controller 192 can control an output voltage polarity, and a direction and amplitude of an output current for each phase A, B, C at the connection 190. Therefore, with a substantially constant RPM of the rotor assembly, the machine 10 can output a standard 3-phase VAC output to power a 3-phase load 206.

It is to be understood that the various embodiments of the present disclosure described herein may be utilized in various orientations and in various configurations, without departing from the principles of the present disclosure. The embodiments are described merely as examples of useful applications of the principles of the disclosure, which is not limited to any specific details of these embodiments.

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of the present disclosure. Accordingly, the foregoing detailed description is to be clearly understood as being given by way of illustration and example only, the spirit and scope of the present invention being limited solely by the appended claims and their equivalents.

What is claimed is:

1. A homopolar machine that converts between mechanical and electrical energy, the machine comprising:
a stator with first and second magnetic pole faces, the first and second pole faces being connected via a structure;
a rotor assembly with a first rotor fixedly attached to a second rotor via a shaft, wherein the first rotor, the second rotor, and the shaft rotate in unison about a center axis of the rotor assembly, wherein the rotor assembly rotates relative to the stator, and wherein each of the first and second rotors include at least one magnetic pole face;
a first gap between the stator's first magnetic pole face and the first rotor;
a second gap between the stator's second magnetic pole face and the second rotor;
a first electrical conductor, wherein multiple portions of the first electrical conductor are fixedly attached to at least one of the first and second magnetic pole faces of the stator, wherein the multiple portions are positioned in at least one of the first and second gaps, and wherein current travels through each of the multiple portions in the same direction relative to the respective pole face to which the multiple portions are attached; and
at least one magnetic source which creates a magnetic flux field loop, wherein the magnetic flux field loop rotates about the center axis of the rotor assembly, thereby causing the conductor portions of the first electrical conductor to pass through the magnetic field loop as the loop rotates.

2. The machine of claim 1, wherein magnetic flux flowing in the loop flows along flux stream lines, and wherein the flux stream lines pass through at least
1) the first rotor,
2) the magnetic pole face of the first rotor,
3) the first gap,
4) the conductor portions,
5) a portion of the structure,
6) the second gap,
7) the second rotor,
8) and back to the first rotor.

3. The machine of claim 1, wherein the first electrical conductor is positioned on the stator in a manner that substantially prevents creation of inductance.

4. The machine of claim 1, wherein application of a voltage potential between opposite ends of the first electrical conductor causes current to flow through the first electrical conductor, and wherein the current flow though the first electrical conductor causes rotation of the rotor assembly relative to the stator.

5. The machine of claim 1, wherein rotation of the rotor assembly rotates the magnetic flux field loop and thereby creates current flow in the first electrical conductor as the portions of the first electrical conductor passes through the rotating magnetic flux field loop, and wherein the current flow creates a voltage potential between opposite ends of the first electrical conductor.

6. The machine of claim 1, wherein the at least one magnetic source comprises an electromagnet with an excitation coil, wherein conductors of the excitation coil are wrapped circumferentially around the shaft of the rotor assembly with a gap between the coil and the shaft, wherein the excitation coil is fixedly attached to the structure of the stator, and wherein the rotor assembly rotates relative to the coil.

7. The machine of claim 6, wherein application of a voltage to the excitation coil produces the magnetic flux field loop, and wherein a majority of flux stream lines of the magnetic flux field loop travel through the shaft.

8. The machine of claim 1, wherein the at least one magnetic source comprises at least one permanent magnet, wherein the permanent magnet is positioned circumferentially around the shaft of the rotor assembly, wherein the permanent magnet is fixedly attached to the structure of the stator, and wherein the rotor assembly rotates relative to the permanent magnet.

9. The machine of claim 8, wherein the permanent magnet creates the magnetic flux field loop, and wherein a majority of flux stream lines of the magnetic flux field loop travel though the permanent magnet with a minority of the flux stream lines traveling through the shaft.

10. The machine of claim 9, wherein the at least one permanent magnet comprises multiple permanent magnets.

11. The machine of claim 1, wherein the at least one magnetic source comprises at least one permanent magnet, wherein the permanent magnet is a washer-shaped magnet that is positioned circumferentially around the shaft and fixedly attached to the first rotor, and wherein the permanent magnet rotates with the rotor assembly.

12. The machine of claim 11, wherein the permanent magnet creates the magnetic flux field loop, wherein a majority of flux stream lines of the magnetic flux field loop travel though the permanent magnet, and wherein a direction of travel of the flux stream lines from the magnetic pole face of the first rotor is generally parallel with the center axis of the rotor assembly.

13. The machine of claim 1, wherein the at least one magnetic pole face of the first rotor comprises multiple magnetic pole faces and the at least one magnetic pole face of the second rotor comprises multiple magnetic pole faces.

14. The machine of claim 13, wherein a magnetic polarity of each one of the multiple pole faces of the first rotor are the same polarity.

15. The machine of claim 14, wherein a magnetic polarity of each one of the multiple pole faces of the second rotor are the same polarity, and the magnetic polarity of the multiple pole faces of the first rotor are opposite the magnetic polarity of the multiple pole faces of the second rotor.

16. The machine of claim 15, wherein each of the pole faces of the first rotor are circumferentially spaced apart, and each of the pole faces of the second rotor are circumferentially spaced apart.

17. The machine of claim 13, wherein the stator comprises first and second cylindrical rings, wherein each of the first and second rings have an inner diameter and an outer diameter, and wherein a center axis of each ring is aligned with the center axis of the rotor assembly.

18. The machine of claim 17, wherein the first magnetic pole face of the stator is an inner cylindrical surface of the first ring and the second magnetic pole face of the stator is an inner cylindrical surface of the second ring, and wherein the first and second rings are fixedly attached to the structure.

19. The machine of claim 18, wherein the stator further comprises third and fourth magnetic pole faces, wherein the third magnetic pole face comprises multiple magnetic pole faces positioned at the outer diameter of the first ring, and the fourth magnetic pole face comprises multiple magnetic pole faces positioned at the outer diameter of the second ring.

20. The machine of claim 19, wherein the first electrical conductor is helically wrapped around the first ring between the first pole face and multiple recesses in the outer diameter of the first ring, wherein each one of the multiple recesses are positioned between adjacent ones of the multiple pole faces of the third pole face, wherein a second electrical conductor is helically wrapped around the second ring between the second pole face and multiple recesses in the outer diameter of the second ring, and wherein each one of the multiple recesses are positioned between adjacent ones of the multiple pole faces of the fourth pole face.

21. The machine of claim 20, wherein the multiple portions of the first electrical conductor are positioned side-by-side along the inner cylindrical surface of the first ring forming a row of the conductor portions of the first conductor, and wherein multiple portions of the second electrical conductor are positioned side-by-side along the inner cylindrical surface of the second ring forming a row of the conductor portions of the second conductor.

22. The machine of claim 21, wherein rotation of the rotor assembly creates electrical current in each of the first and second conductors as the portions of the first and second conductors pass through the magnetic flux field loop, wherein current in each of the portions of the first conductor flow in a same direction relative to the inner cylindrical surface of the first ring, and wherein current in each of the portions of the second conductor flow in a same direction relative to the inner cylindrical surface of the second ring.

23. The machine of claim 1, wherein the shaft is a cylindrical tube with a radially reduced portion which is rotatably mounted to a portion of the structure, wherein the at least one magnetic source comprises multiple permanent magnets mounted to an inner surface of the cylindrical tube, wherein the permanent magnets are positioned radially outward from the stator and the permanent magnets rotate around the stator.

24. The machine of claim 1, wherein the magnetic source comprises multiple permanent magnets, wherein at least one of the multiple permanent magnets is mounted to the magnetic pole face of the first rotor with a north pole facing the first magnetic pole face of the stator, and wherein at least one of the multiple permanent magnets is mounted to the magnetic pole face of the second rotor with a south pole facing the second magnetic pole face of the stator.

25. The machine of claim 1, wherein the first and second rotors are each washer-shaped, wherein a washer-shaped permanent magnet is mounted to at least one of the first and second rotors, wherein the stator includes a washer-shaped disk, wherein the washer-shaped disk of the stator is positioned between the first and second washer-shaped rotors, wherein the shaft of the rotor assembly passes from the first rotor through a center of the washer-shaped disk to the second rotor, and wherein the rotor assembly rotates about a center axis of the rotor assembly.

26. The machine of claim 1, further comprising:
a third pole face on the stator, wherein the rotor assembly further comprises a third rotor fixedly attached to the shaft, wherein the third rotor rotates with the rotor assembly;
a third gap between the stator's third magnetic pole face and the third rotor;
a second electrical conductor, wherein multiple portions of the second electrical conductor are fixedly attached to the second magnetic pole face of the stator, wherein the multiple portions of the second conductor are positioned in the second gap, and wherein current travels through each of the multiple portions of the second conductor in a same direction relative to the second pole face;
a third electrical conductor, wherein multiple portions of the third electrical conductor are fixedly attached to a third magnetic pole face of the stator, wherein the multiple portions of the third conductor are positioned in a third gap, and wherein current travels through each of the multiple portions of the third conductor in a same direction relative to the third pole face; and
an electrical connection of a three phase circuit to the first, second, and third conductors, with separate phases connected to each of the first, second, and third conductors.

27. A machine of claim 26, wherein the three phase connection is a three phase connection to a power source, and wherein application of three phase power via the three phase connection causes voltage polarity and current amplitude in each of the first, second, and third conductors to vary, wherein the magnetic source comprises first and second electromagnets, with the first electromagnet longitudinally positioned between the first and second rotors along the shaft, and with the second electromagnet longitudinally positioned between the second and third rotors along the shaft, wherein a controller controls first and second bi-directional excitation drivers which control voltage amplitude and voltage polarity applied to the respective first and second electromagnets, wherein the varied voltage polarity and varied voltage amplitude applied to the first and second electromagnets synchronizes a direction and magnitude of flux flow in the multiple loops which maintains a constant direction of torque applied to the rotor assembly, thereby converting electrical energy into mechanical energy.

28. A machine of claim 26, wherein the three phase connection is a three phase connection to a power load, and wherein application of a torque to the rotor assembly causes the rotor assembly to rotate, wherein the magnetic source comprises first and second electromagnets, with the first electromagnet longitudinally positioned between the first and second rotors along the shaft, and with the second electromagnet longitudinally positioned between the second and third rotors along the shaft, wherein a controller controls first and second bi-directional excitation drivers which control voltage amplitude and voltage polarity applied to the respective first and second electromagnets, wherein the varied voltage polarity and varied voltage amplitude applied to the first and second electromagnets creates varied voltage polarity and voltage magnitude at the 3-phase connection with a constant rotation direction of the rotor assembly, thereby converting mechanical energy into electrical energy.

29. A method of converting between mechanical energy and electrical energy, the method comprising the steps of:
connecting a stator with first and second magnetic pole faces to a housing of a machine;
attaching first and second rotors to a shaft thereby forming a rotor assembly, wherein the first rotor, the second rotor, and the shaft rotate in unison about a center axis of the rotor assembly, wherein the rotor assembly rotates relative to the stator, and wherein each of the first and second rotors include at least one magnetic pole face;
assembling the rotor assembly into the housing, thereby forming a first gap between the stator's first magnetic pole face and the first rotor, and a second gap between the stator's second magnetic pole face and the second rotor;
wrapping an electrical conductor around at least a portion of the stator, wherein multiple portions of the electrical conductor are fixedly attached to at least one of the first and second magnetic pole faces of the stator, wherein the multiple portions are positioned in at least one of the first and second gaps, and wherein current travels through each of the multiple portions in the same direction relative to the respective pole face to which the multiple portions are attached; and
creating a magnetic flux field loop in the machine by positioning at least one magnetic source within the machine;
rotating the magnetic flux field loop about the rotor's center axis, thereby causing the conductor portions of the electrical conductor to pass through the magnetic field loop as the loop rotates; and
converting electrical energy to mechanical energy or mechanical energy to electrical energy in response to the rotating the magnetic flux field loop through the electrical conductor portions.
